(19) United States
(12) Patent Application Publication
(10) Pub. No.: US 2016/0362799 A1
(43) Pub. Date: Dec. 15, 2016

(54) ELECTROLYSIS SYSTEM FOR PRODUCING HYDROGEN, OXYGEN AND ELECTRICAL ENERGY USING RENEWABLE ENERGY (SOLAR AND WIND) AND A MIXTURE OF DESALINATED SEA WATER AND DIFFERENT CHEMICAL COMPONENTS

(71) Applicant: Octavio RAMOS AGUNDO, Esplugues de Llobregat, Barcelona (ES)

(72) Inventor: Octavio RAMOS AGUNDO, Barcelona (ES)

(21) Appl. No.: 15/032,788

(22) PCT Filed: Oct. 28, 2014
(86) PCT No.: PCT/ES2014/000187

§ 371 Date: Aug. 1, 2016

(30) Foreign Application Priority Data
Oct. 29, 2013 (ES) P201301030

(51) Int. Cl. C25B 1/04; C25B 9/06; H01M 8/0656; C25B 11/04; H01M 10/46; C25B 9/04; C25B 15/08

(52) U.S. Cl. CPC C25B 1/04; C25B 9/04; C25B 9/06; C25B 15/08; C25B 11/04; H01M 10/46; H01M 8/0656; H01M 2250/20; H01M 2250/10

(57) ABSTRACT

The invention relates to a system for producing hydrogen, oxygen and electrical energy from renewable energy and a mixture of sea water which, once desalinated, is mixed with different chemical components. The invention relates to the field of electrochemistry. In particular, the invention relates to a system for producing hydrogen and oxygen and electrical energy, based on harvesting renewable energy that is conveyed to a desalination means and electrolysers which produce hydrogen and oxygen in such a way that the product is directed to compressors which in turn direct the product to receptacles that can withstand the pressure at which said product is stored for the distribution and sale thereof. Alternatively, the hydrogen is conveyed to a fuel cell to be transformed into electrical energy, and converted, using an inverter, into alternating current to be delivered to the electrical grid. In this way, when for any reason the hydrogen and the oxygen produced cannot be stored, they can be directed to the fuel cell which transforms the excess portion from the production of hydrogen into electrical energy.

### EXPLANATION

Production system of hydrogen, oxygen and electricity from energy renewable and a mixture of one desalinated seawater mixes with time various chemical components such as sodium hypochlorite, sodium hydroxide, acid nitric, or others. To facilitate electrolysis. Industrial electrochemical sector.

Being based on the use of solar energy and photovoltaic wind power renewable energy supply to the battery pack, the Desalination or electrolyser. See section Drawings FIG. 1.

The electrolyzer has two electrodes, cathode and anode as can be steel stainless steel, aluminum, nickel, molybdenum or other metal within a mixture of desalted seawater and various chemical components for the optimization of electrolysis.

Electrolysis is carried out from renewables and a mixture of seawater desalted once a mixed with various chemical components, which it makes the energy consumption of the network and the waste produced are practically nil.

The electrolysis process produces vapors in the cathode are hydrogen collected by a compressor and sent to the hydrogen pressure corresponding. This process also produces electrolysis at the anode vapors oxygen that are collected by a second compressor and sent to the deposit oxygen to the corresponding pressure.

The system is characterized in that develops an electrolysis process using basic negative electrode for stainless steel and positive electrode for aluminum or other metals, producing a combination of electrolyte with water desalinated mixed with nitric acid, sodium chloride, sodium hypochlorite, hydroxide sodium or similar equivalent, hydrogen and oxygen.

The system is characterized by comprising first means for conducting electrolysis, consisting of a deposit of about 50 m3 of water desalinated sea. Second means consisting of a pump drive for transferring seawater to the main tank and from there to the desalination plant.

The deposit will have a buoy with a locking mechanism opening preventing the passage of water when filled to the desired level.

The system is characterized because it has a charger that will one or two batteries 120 volts or more or any other equivalent set of batteries that is rechargeable by renewable energy (solar or wind) for connection of the two electrodes to cause the reaction of the electrolyte formed by the mixture of sea desalinated water with nitric acid or other similar equivalents within the electrolyzer reservoir. And it has an inverter current drawn by the current into and transforms it into alternating order so pass it to the mains.

System is characterized in that used renewable energy they are solar and wind with possibility also self-generated electric power as all they are complementary to the process.

The system is characterized in that the desalination of which speaks develops in double desalting process. This double desalting water purity favors electrólisis.Y for being purer water this will occur much more H2 and O2 electrodes.

The system is characterized in that the electrodes used in the electrolysis have a special shape that is rectangular (FIG. 3) in order to achieve maximum surface in the electrolytic Cuba (FIG. 2).

The system is characterized in that this rectangular shape of the electrodes allows build with them a kind of combs with plates and give them a separation approximately about 10 cm between plates (FIG. 4).

The system is characterized are also included in the process, a large energy storage batteries, which favor the continued development of it and electrolyzers keeps constantly running without power cuts.

The system is also characterized by the absence of distillation will not be used batteries special filters or the number of filters required for this, which makes it much more economical and simple process operations.

The system is characterized by obtaining more amount of the H2 and O2 equipment depreciation will take place in shorter space of time.

The system is characterized by shortening the payback time. It recouped many whole process.

All of which will make the technical process and economically sustainable.

### INDUSTRIAL APPLICATION FIELD

Herein a production system described hydrogen, oxygen and electricity from renewable energies and a mixture of seawater once desalinated mixed with various chemical components, which may be of general application, application in home use, and also application in the automotive industry, railway, nautical, of the aviation and other industries in general different.

### BACKGROUND OF THE INVENTION

One of the big problems we encounter when proceeding with systems production for the hydrogen and oxygen is the enormous cost involved facilities to achieve that objective.

Since it is very high cost methods that reforming and craking currently used for obtaining hydrogen.

In order to provide a solution to this important problem and so impact from the economic point of view, is designed and developed this system for the production of hydrogen, oxygen and electricity by use of renewable energy (solar and wind) and a mixture of seawater desalinated and various chemical components, carried out in an electrolyzer, to obtain in the process, the desired results of hydrogen from desalinated seawater, with the added advantage of getting well with this added oxygen as a product.

The main advantages of this system for the production of hydrogen, oxygen and electricity using renewable energy (solar and wind) and a mixture of desalinated seawater and various components chemicals, are:

1.—Low cost in the electrolytic process, because the raw materials used are desalinated seawater and renewable energy for the production of hydrogen and oxygen.

2.—The energy consumption is from renewable energies.

3.—Once written off facilities will be very viable economically production of hydrogen and oxygen that may be used in sectors industrial and automotive, railway, nautical, aviation, and various other industries in general.

### DESCRIPTION OF THE DRAWINGS

FIG. 1 shows the electrolysis process in three distinct phases.

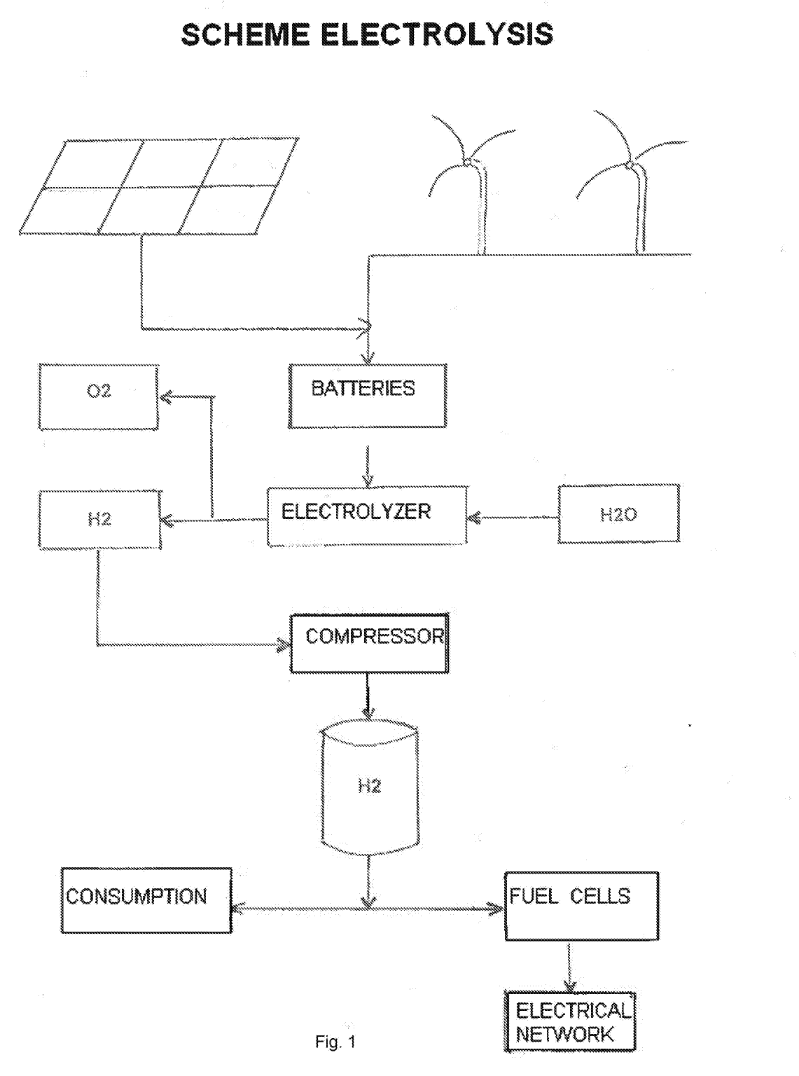

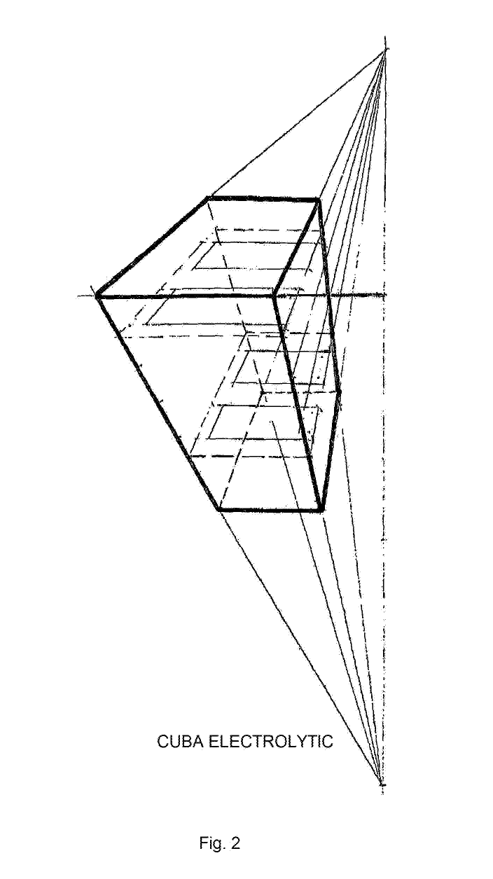

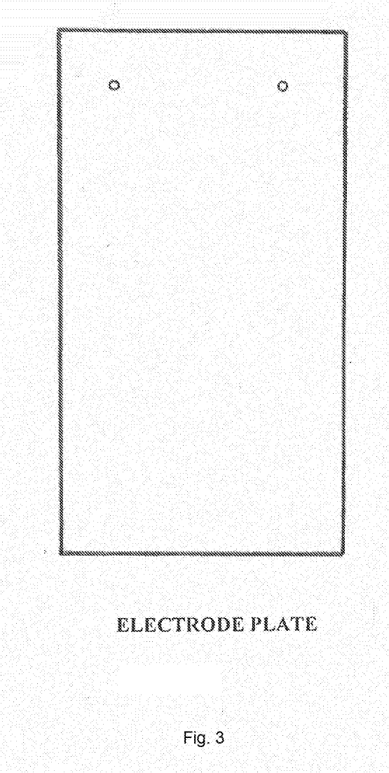

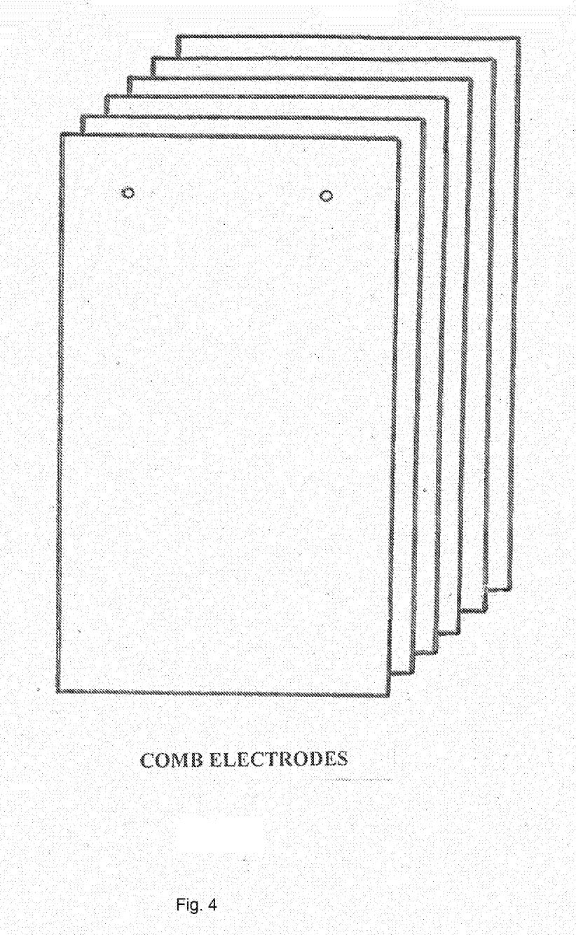

The first phase, consisting of the wind and solar parks that generate energy that will go to a set of batteries. The seawater tank will be pumped one that goes to a boiler that runs desalination.

In a second phase this water will be pumped into the tank where it runs the electrolysis. Here the hydrogen and oxygen are generated.

In a third phase, each gas, one independent of the other, will be compressed and returned to their respective storage tanks. Or the stack fuel to generate electricity for the grid.

In FIG. 2 is shown in perspective with several electrolytic plates Cuba electrodes.

In FIG. 3, the base plate which is the electrode shown.

In FIG. 4, the electrode assembly forming part of comb shown electrodes.

### SIGNIFICANT DOCUMENTS

Brochures hydrogen Iberdrola
Es.wikipedia.org/wiki/Hidrógeno
www.lenntech.com/espanol/tabla-peiodica/H.htm
aeh2.org
www.motordehidrogeno.net
www.hidrogeno.org

1. Production system of hydrogen, oxygen and electrical energy from renewable energy and a mixture of desalinated seawater mixed with various chemical components, characterized in that develops a process electrolysis through the basic use of negative electrode for stainless steel or other metals and positive for aluminum or other metals electrode, producing the combination of the electrolyte and which desalinated seawater is once mixed with nitric acid, sodium chloride, sodium hypochlorite, sodium hydroxide other similar equivalents.

2. Production system of hydrogen, oxygen and electrical energy from renewable energy and a mixture of desalinated seawater mixed with various chemical components according to claim 1, characterized by developing the result of an electrolysis process that produces in the cathode hydrogen vapors are collected by a compressor and are sent to deposit the corresponding hydrogen pressure.

3. Production system of hydrogen, oxygen and electrical energy from renewable energy and a mixture of desalinated seawater mixed with various chemical components according to claim 1, characterized by developing the result of an electrolysis process that produces Anode oxygen vapors which are collected by a second compressor and are sent to deposit oxygen to the corresponding pressure.

4. Production system of hydrogen, oxygen and electrical energy from renewable energy and a mixture of desalinated seawater mixed with various chemical components according to claim 1, characterized by having a stainless steel electrode which is connected to negative pole of the battery and the other electrode made of aluminum or any other metal that connects to the positive pole of the battery.

5. Production system of hydrogen, oxygen and electrical energy from renewable energy and a mixture of desalinated seawater mixed with various chemical components according to claim 1, characterized by the use as a basic and fundamental element of stainless steel electrodes connected to the negative pole of the DC produced by the battery electrolyte for the reaction and as a result the production of hydrogen and oxygen water desalinated sea.

6. Production system of hydrogen, oxygen and electrical energy from renewable energy and a mixture of desalinated seawater mixed with various chemical components according to claim 1, characterized by comprising the use of aluminum electrodes connected positive pole of the direct current produced by the battery for the reaction of electrolyte and consequently the production of hydrogen and oxygen of desalinated sea.

7. Production system of hydrogen, oxygen and electrical energy from renewable energy and a mixture of desalinated seawater mixed with various chemical components according to claim 1, characterized by the use of nickel electrodes connected negative pole of the direct current produced by the battery for the reaction of electrolyte and consequently the production of hydrogen and oxygen of desalinated sea.

8. Production system of hydrogen, oxygen and electrical energy from renewable energy and a mixture of desalinated seawater mixed with various chemical components according to claim 1, characterized by comprising using molybdenum electrodes connected the negative pole of the direct current produced by the battery for the reaction of electrolyte and consequently the production of hydrogen and oxygen of desalinated sea.

9. Production system of hydrogen, oxygen and electrical energy from renewable energy and a mixture of desalinated seawater mixed with various chemical components according to claim 1, characterized by comprising the use of electrodes of any metal connected to the positive or negative pole of the direct current produced by the battery electrolyte for the reaction and as a result the production of hydrogen and oxygen from seawater.

10. Production system of hydrogen, oxygen and electrical energy from renewable energy and a mixture of desalinated seawater mixed with various chemical components according to claim 1, characterized by comprising the use of a composition of desalinated water marina, mixed with a proportion of sodium chloride or other similar equivalent to the formation of the electrolyte.

11. Production system of hydrogen, oxygen and electrical energy from renewable energy and a mixture of desalinated seawater mixed with various chemical components according to claim 1, characterized by comprising the use of a composition of desalinated water marine, mixed with a proportion of sodium hypochlorite or other similar equivalent to the formation of the electrolyte.

12. Production system of hydrogen, oxygen and electrical energy from renewable energy and a mixture of desalinated seawater mixed with various chemical components according to claim 1, characterized by comprising the use of a composition of desalinated water marina, mixed with a proportion of sodium hydroxide or other similar equivalent to the formation of the electrolyte.

13. Production system of hydrogen, oxygen and electrical energy from renewable energy and a mixture of desalinated seawater mixed with various chemical components according to claim 1, characterized by comprising the use of a composition of desalinated water marina, mixed with a proportion of nitric acid or the like equivalent to the formation of the electrolyte.

14. Production system of hydrogen, oxygen and electrical energy from renewable energy and a mixture of desalinated seawater mixed with various chemical components according to claim 1, characterized by comprising first means for conducting the electrolysis, consisting of a deposit of about 50 m³ of desalinated sea.

15. Production system of hydrogen, oxygen and electrical energy from renewable energy and a mixture of desalinated seawater mixed with various chemical components according to claim 1, characterized by comprising second means consisting of a pump drive for transferring seawater to the main tank and from there to the desalination plant.

16. Production system of hydrogen, oxygen and electrical energy from renewable energy and a mixture of desalinated seawater mixed with various chemical components according to claim 1, characterized by the deposit will have a buoy with a locking mechanism—opening to prevent the passage of water when filled to the desired level deposit cited according to claim 14.

17. Production system of hydrogen, oxygen and electrical energy from renewable energy and a mixture of desalinated seawater mixed with various chemical components according to claim 1, characterized by having a charger that will one or two 120-volt batteries or more or any other equivalent set of rechargeable batteries is by renewable energy (solar or wind) for connecting the two electrodes provoke the reaction of the electrolyte formed by the mixture of desalinated water marina with nitric acid or other similar equivalents within the deposit electrolyzer.

18. Production system of hydrogen, oxygen and electrical energy from renewable energy and a mixture of desalinated seawater mixed with various chemical components according to claim 1, characterized by having a fuel tank which shall be the element to use in case you may not wish to store hydrogen but only wants the conversion of this electric energy.

19. Production system of hydrogen, oxygen and electrical energy from renewable energy and a mixture of desalinated seawater mixed with various chemical components according to claim 1, characterized by having a power inverter which takes the it into and transforms it into DC and transforms it into alternate power in order to transfer it the electric network.

20. Production system of hydrogen, oxygen and electrical energy from renewable energy and a mixture of desalinated seawater mixed with various chemical components according to claim 1, characterized by renewable energies which are being used are solar and wind with the possibility of also power energy self-generated because all of them are complementary to the process.

21. Production system of hydrogen, oxygen and electrical energy from renewable energy and a mixture of desalinated seawater mixed with various chemical components according to claim 1, characterized by desalination being developed in a double process of desalinated, this double desalination favors the purity of the water for electrolysis, as water is purer, this will help produce greater quantities of H₂ and O₂ in the electrodes.

22. Production system of hydrogen, oxygen and electrical energy from renewable energy and a mixture of desalinated seawater mixed with various chemical components according to claim 1, characterized by electrodes being used in electrolysis have a special form that is rectangular with the purpose of achieving maximum surface in the electrolytic tank.

23. Production system of hydrogen, oxygen and electrical energy from renewable energy and a mixture of desalinated seawater mixed with various chemical components according to claim 1, characterized by its electrodes' rectangular form that allow to build with a type of combs with the plates and give them a separation of about 10 cm between plates.

24. Production system of hydrogen, oxygen and electrical energy from renewable energy and a mixture of desalinated seawater mixed with various chemical components according to claim 1, characterized by being included in the Process, some great accumulating energy batteries which favor the continuous development and maintains eletrolyzers in constant function without energy cuts.

25. Production system of hydrogen, oxygen and electrical energy from renewable energy and a mixture of desalinated seawater mixed with various chemical components according to claim 1, characterized by not having distillation, the special filter batteries nor the number of filters required for this will not be used, which makes process operations more economic and simple.

26. Production system of hydrogen, oxygen and electrical energy from renewable energy and a mixture of desalinated seawater mixed with various chemical components according to claim 1, characterized by being desalinated twice and by water being purer you achieve a greater amount of H₂ and O₂.

27. Production system of hydrogen, oxygen and electrical energy from renewable energy and a mixture of desalinated seawater mixed with various chemical components according to claim 1, characterized by obtaining a greater amount of H₂ and O₂, the amortization of equipment is carried out in a shorter time.

28. Production system of hydrogen, oxygen and electrical energy from renewable energy and a mixture of desalinated seawater mixed with various chemical components according to claim 1, characterized by shortening the amortization time which increases profitability in all the process, which will make it a technically and economically sustainable process.
